(19) United States
(12) Patent Application Publication
(10) Pub. No.: US 2011/0277040 A1
(43) Pub. Date: Nov. 10, 2011

(54) Methods for electronically communicating with a person where the person's e mail address or cell phone number is unknown

(76) Inventor: Joanne Bliss, Plantation, FL (US)

(21) Appl. No.: 13/068,098

(22) Filed: May 2, 2011

Related U.S. Application Data
(60) Provisional application No. 61/343,871, filed on May 5, 2010.

(51) Int. Cl. G06F 21/24

(52) U.S. Cl. 726/29; 726/27

(57) ABSTRACT

Methods and apparatus are provided to allow a person to obtain the e mail address and or cell phone number of another person. However at least two blocks are provided to assure that a computer cannot obtain the same. A Directory of phone numbers and or e mail address is created by voluntary permission of each registrant. Each registrant is able to add personal and additional blocks to prevent unwanted seekers, even humans, from obtaining any information not permitted by an individual registrant. Accordingly, each registrant is in control of the information obtained by a seeker.

This application is related to and claims the benefits of provisional application No. 61/343,871, filed on May 5, 2010, by the present inventor, entitled Methods for Electronically Obtaining and Accessing Personal Information

### FIELD OF THE INVENTION

This invention relates in general to the field of electronically obtaining and accessing personal data and in particular methods for obtaining and accessing a person's cell phone number and e-mail address as well as personal background information as provided by the registrant

### PROBLEMS EXISTING IN THE PRIOR ART

There exist problems in communicating with a person when that person's cell phone number and or e-mail address is unknown. In today's day and age, this creates a major problem because of the ever diminishing use of land lines, the party not being there, and the rapidly increasing use of cell phones and e-mails. In fact, many persons and even businesses do not have or use a land line. This developing situation is resulting in the loss of communication with past and even present friends and businesses.

For example a person's wife died after three years of contacting the illness. The husband attempted to notify long time friends of the wife. It was not possible because the friends had moved to another township and the regular search engines revealed nothing. Accordingly the friends could no be notified of the wife's death. This is a true story.

Today there exists no way of obtaining a person's cell phone number or e-mail address, unless of course the person provides the same orally, in written correspondence, by business card, etc.

Cell phones are probably the most the most widely held and used small electronic device by members of the present day society. Teens, business persons, politicians, house persons, and even motorcyclists use cell phones. They are so convenient that they have virtually replaced two way radios in cars and small boats. They are the best mode of communication in emergency situations e.g. when in an accident, or the car breaks down, or a person senses danger. Persons deciding on a purchase are often seen in communication with another describing the product or price. The versatility and convenience of cell phones lies of course in their portability and smallness in size in that the phones can be used in virtually any location that the user is located. The use of cell phones has become a necessity and not a luxury.

The use of e-mails and texting have also become wide spread. They are faster and quicker than U.S. Mail, and a written record is created. It certainly is more convenient than written mail or even a fax. Indeed, e-mails can even be received by certain cell phones. Moreover an e-mail can be sent simultaneously and instantly to a large number of recipients, such as group of members of an organization, school class members, etc., by a single stroke

However, unless a person's cell number or e-mail address is known there is no way find that person or communicate with him or her. For unknown reasons there is no such Directory. There are services that purport to “find” a long forgotten friend or even a recent acquaintance, for a fee. But information must be supplied that is often not available or unknown; which if such information was available or known, the finding service would not be needed.

Actually, the reason is not unknown. An exceedingly large number of people and businesses simply do not want their cell phone number and e mail address known. Why? Because too many are striving to make money via the internet using personal data. A simple search can result in hours of frustrating energy because of sites which are only links to their own site and do not reveal any useful information unless the searcher lists his or her e mail address. Even then the sought for information is often not available. Of course there are legitimate sites if they can be found among the thousands provided by the search engine.

The sites seeking primarily the e mail addresses gather the same and sell them to spammers which are businesses or organizations which use a computer to automatically send thousands of e mails for advertising purposes. The spammers are exceedingly clever using enticing language to coerce people into opening the e mail. Sometimes it's a virus. The more people that open the unsolicited e mail the more the spammer can sell advertising. Some people will do anything for money even if it tramples over your privacy.

The above problems notwithstanding there is still a need for an e mail and cell phone Directory

### BRIEF SUMMARY OF THE INVENTION

The present invention lessens these prior art problems in a simple and effective manner while protecting the registrant's personal data as determined in part by the registrant.

The present invention includes a web site Directory primarily dedicated to e mail addresses and cell phone numbers. Within the web site are a plurality of registrants who desire to have their e mail address available and or their cell phone number. Any other personal information the registrant wants to be known can also be listed and an e-mail Directory and a web site. In operation however, the web Directory provides a number of degrees of protection regarding information a registrant does not want known and protection against a computer from accessing the Directory's data base. The web site is accessed the same as any other web site. The web site is user friendly and is pro-active. Its purpose to allow the exchange of personal information, primarily an e-mail address and or a cell phone number and of course, a name. A main aspect of the process or method is that it is completely voluntary and may or may not involve a fee by the registrant or a person seeking the information of a registrant. However the site is protected from spammers using computers to gain the information. Additional protection can be provided by each registrant.

In use, in its simplest form, a person decides whether he or she wants to list a cell phone number and or an e-mail address. The web site provides a form where a person can list the name and cell phone number and or e-mail address associated with the registrant's name. If additional personal information the registrant wants to disclose, the form will allow for providing for the same.

The web site creates a file for each registrant wherein the information is stored. A seeker but not a computer can access the site information by simply using the site address. But the site will require authentication before any information on the site can be accessed, The seeker will then, for example. input a name. The site will then display all of the registrants having that name. The registrants that will allow some but not all data will be marked as protected. The amount of protection is entirely up to the registrant. If more than one registrant is found having the particular name or similar thereto. The seeker can access the data for each registrant. Additional information provided by the registrant, e.g. name, address, business name, nick names etc. will allow the seeker to find the person he is looking for. Again, depending on how the registrant wants to be found and by whom the inventive method will provide for such. For example, a person in the military known by the nickname “Scosh” would be found by those in the military by those who were familiar with that nickname Alternatively, the person listing his e-mail address and his real name can list one of the free e-mail addresses which are readily available or the person can list his or her nickname in conjunction with the carrier used by the person.

The inventive method can provide a certain degree of security in the event the registrant so desires. Of course there will be many instances where a person wants to be found, much in the same manner as with a telephone Directory. Then that person or for example, a small or even a large business would provide no security restrictions so that a seeker can readily obtain the contact information. This would eliminate the disadvantageous of web sites which do not list contact information but require the seeker's personal information which is usually followed by a plethora of unsolicited advertisements.

### BRIEF DESCRIPTION OF THE DRAWINGS

Various other objects, advantages, and features of the invention will become apparent to those skilled in the art from the following discussion taken in conjunction with the following drawings, in which:

FIG. 1 is a rendition of a typical prior art method of protecting against spamming

FIG. 2 is a simplified flow chart illustrating the method of the present invention.

### DESCRIPTION OF THE PREFERRED EMBODIMENTS

As required, detailed embodiments of the present invention are disclosed herein; however, it is to be understood that the disclosed embodiments are merely exemplary of the invention which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed method or structure.

The present invention includes a Directory primarily dedicated to e mail addresses and cell phone numbers. The Directory comprises a web site having an appropriate name such as “e me Directory/Purple Pages”. The web site is accessed the same as any other web site. The web site is user friendly and is pro-active. Its purpose to allow the exchange of personal e-mail addresses and cell phone numbers. Within the web site exists data from a plurality of registrants who desire to have available their e mail address and or their cell phone number. Any other personal information the registrant wants to be known can also be listed On the other hand, the registrant can limit the information a seeker who can access web site. Flexibility with a high degree of protection is a main intent of the invention.

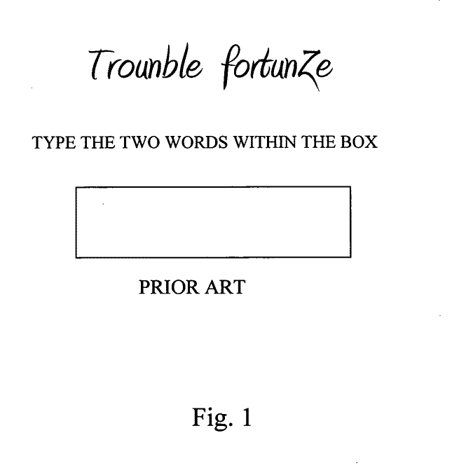

In its simplest form the home page of the web site can be accessed by anyone even a computer. However a computer is not permitted to seek any information contained within the Directory or about the registrants in the data base of the web site. A simple and well known computer block comprising squiggly words which can only be translated by a human is used with the inventive method to block out computers. One such well known computer block comprises the method used by “reCAPTCHA” and owned by “GOOGLE”. ““CAPTCHA” is a free program that can tell whether its user is a human or a computer. CAPTCHAs are used by many websites to prevent abuse by automated programs used to generate spam” (Copyrighted by CAPTCHA}. See FIG. 1 which comprises an original example of the squiggly words that a seeker must correctly translate before the seeker has further access to the Directory. In fact the U.S. Patent Office itself uses the same to prevent only legitimate users to access its data. Accordingly, the term squiggly words as used herein comprise but are not limited to words having real letters but arranged in a wave fashion, having a blot of ink or other substance overlaying certain letters, having a random line of variable thickness pass through some of the letters or some of the letters seemingly using the same stroke, see for example FIG. 1.

Once a seeker has access to the data stored in the Directory, the seeker must input his name, address, and e mail address and a password. To help narrow the search, the Directory may require the state and city of the person being sought. The Directory then provides permission to seek the e mail address and or cell phone number of the person he is seeking. The name and any additional data of the person being sought is typed in.

The registrants themselves are able to provide the degree of protection they desire regarding a seeker of information. The Directory however provides another set of squiggly words for each registrant just in case a computer was able to overrides the first mode of protection.

Once the seeker correctly accesses the Directory data base, one or more names responding to the person sought by the seeker appears on a separate screen. In order to access a particular registrant's data, the seeker must again translate the two squiggly words assigned by the Directory. This is the simplest form of protection afforded by the Directory. Each registrant has the ability to impose further blocks as he or she desires. For example, the registrants can fall into the following classes which are not intended to be limiting.

The first class will allow anyone to the access his data base. The next class will allow a seeker to only access his cell phone number. Should this cause harassment to the registrant he can use the Federal numbers to block additional calls. A third class could comprise a registrant who will allow access to both the email address and cell phone number provided the seeker is able to correctly answer questions such as where he was born, what school he attended, name other friends, etc. the list and the amount of available protection is endless Another class of registrants will under certain circumstances provide a his e mail address and cell phone number but may not want any personal data revealed. Thus a block can be put on the personal data to the extent desired.

Yet another way to provide the registrant with additional protection is for the registrant to list one of the free e mail address or on the additional address provided by the registrant's carrier. In this manner the registrant can preview the incoming e mail to determine if a response is desired.

The person who wants anybody and everybody to know his or her e mail or cell phone number puts no restrictions on the data. However, the web Directory is not so easily convinced that the seeker is legitimate. Therefore the web Directory requires that the seeker translates one or more an anti-bot squiggly words that can not be translated by a computer. Automatically then, the registrants are protected from unsolicited advertisements from business or organizations that have gotten his or her e mail from a prior purchase, search, or other site which requires a listing of an e mail address.

In the unlikely event that a spammer could eventually create a program where a person makes the initial contact with the inventive Directory is made by a human who translates the squiggly words thereby giving access to the Directory's data base and then link up with a computer that spams the entire Directory. However, the inventive method requiring translation of another set of squiggly words protects against even this possibility.

As noted above, the inventive method can be especially useful for a business. A typical search by today's search engines provides so many hits that it almost impossible to find the actual business. Many web sites are set up to lead a searcher into believing he has found the business he is seeking, only to have the web site link the seeker to web site for a different business. The present inventive method is not intended to be a search engine to be taken advantage of by various questionable business techniques. Only an actual business and not links to other similar businesses or a “listing” of such similar businesses will be permitted in the Directory. In this manner a registrant will not be exposed to unnecessary spam.

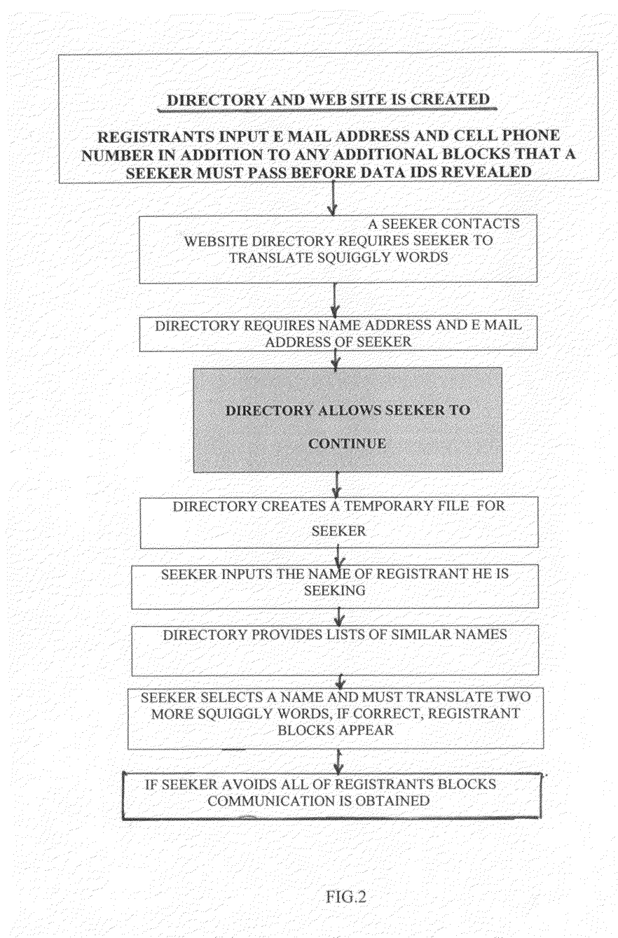

While the Directory is intended to provide e mail addresses and cell phone numbers to friends, business associates, former military personnel or business seeking business information the Directory allows for the input of any personal data a registrant feels will help a friend ascertain that the registrant is the person or business he is seeking The amount and type of personal data input by the registrant is strictly up to the registrant. FIG. 2 illustrates a simplified flow chart illustrating how an embodiment of the present invention works in operation

If a true emergency exists or a valid seeker cannot find the person or business he is seeking, he can access the Directory by translating the two initial blocks and leaving a message to the person he is seeking explaining the nature of his inquiry and the reason he cannot find the person he is seeking. The Directory can list the names and information of the seekers which can be accessible to all registrants who then can ignore the same or respond as desired.

While the invention has been described, disclosed, illustrated and shown in certain terms or certain embodiments or modifications which it has or may assumed in practice, the scope of the invention is not intended to be nor should it be deemed to be limited thereby and such other modifications or embodiments as may be suggested by the teachings herein are particularly reserved especially as they fall within the breadth and scope of the drawings and description of the invention here appended.

I claim:

1. A method for electronically communicating with a person where the person's e mail address or cell phone number is unknown, comprising the steps of:
creating a t directory having a home page that is accessible via the internet; and
providing at least two or more separate means for preventing access to the data within the directory by a computer.

2. The method of claim 1 wherein said directory contains e mail addresses voluntary supplied by a plurality of registrants.

3. The method of claim 1 wherein said directory contains cell phone numbers voluntary supplied by a plurality of registrants.

4. The method of claim 1 wherein a first computer block comprises correct translation of at least one squiggly word, said computer block being provided by a home page of said directory.

5. The method of claim 1 wherein a second computer block comprises correct translation of at least one other squiggly word, said computer second block being provided by said directory for each registrant.

6. The method of claim one including the step of adding the names of a plurality of voluntary registrants to said directory.

7. The method of claim 6 including the step of providing means to each registrant to add additional blocks to their data for preventing an unwanted person from accessing the data.

8. The method of claim 6 including the step of providing each registrant with the ability to control exactly what data is to be made accessible to a seeker who has overcome all blocks.

9. Apparatus comprising: a website access able over the internet'
a home page associated with said website accessible by either a person or a computer,
said home page providing a block preventing further access to said website by a computer can only access said home page.
said website containing a directory of persons voluntarily submitting their e mail address,
said website creating a file for each registrant,
said website providing a second computer block associated with each per's name

10. The apparatus of claim 9 wherein said directory includes the cell phone number of the registrants.

11. The apparatus of claim 9 wherein each registrant can add additional blocks to their data requiring a seeker to overcome all blocks before any personal data in a person's file is disclosed to said seeker.
